(19) United States
(12) Patent Application Publication
(10) Pub. No.: US 2007/0216837 A1
(43) Pub. Date: Sep. 20, 2007

(54) ELECTRO-OPTICAL DEVICE AND ELECTRONIC APPARATUS

(75) Inventor: Takehiro ONO, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/677,733

(22) Filed: Feb. 22, 2007

(30) Foreign Application Priority Data
Mar. 15, 2006 (JP) 2006-070681

(51) Int. Cl. G02F 1/1335

(52) U.S. Cl. 349/117

(57) ABSTRACT

An electro-optical device includes a pair of substrates, and a liquid crystal layer between the substrates. At least one of the substrates has a plurality of scanning lines, a plurality of data lines, and pixel electrodes. The data lines intersect with the scanning lines. The pixel electrodes are disposed in a matrix and correspond to the intersections of the scanning lines with the data lines. When the elastic constant for splay distortion of a liquid crystal material forming the liquid crystal layer is K11, the elastic constant for bend distortion thereof is K33, the dielectric anisotropy thereof is Δε, and the rotational viscosity thereof is γ, the liquid crystal material satisfies the following conditions: 7 pN≦K11≦14 pN; 10 pN≦K33≦16 pN; 12≦Δ∈≦15; and 50 mPa·s≦γ≦100 mPa·s.

### BACKGROUND

1. Technical Field

The present invention relates to an electro-optical device and an electronic apparatus, and more specifically, relates to an electro-optical device including a pair of substrates and a liquid crystal layer therebetween, and an electronic apparatus including the electro-optical device.

2. Related Art

An electro-optical device, or more specifically a so-called twisted nematic (hereinafter referred to as TN) mode liquid crystal display device that operates in a TN mode, includes a liquid crystal layer between a pair of substrates such as glass substrates or quartz substrates. One of the substrates has a plurality of pixel electrodes disposed thereon in a matrix. The other substrate has a common electrode disposed thereon. FIGS. 12 to 14 illustrate the general configuration and the operation of a part of a TN mode liquid crystal display device 200 where pixel electrodes 9a are formed.

A TN mode liquid crystal display device 200 includes a liquid crystal layer 50 between a pair of transparent substrates, that is, a thin film transistor (TFT) array substrate 10 and an opposing substrate 20. The TFT array substrate 10 has pixel electrodes 9a formed on the liquid crystal layer 50 side thereof. The pixel electrodes 9a are transparent conductive layers formed of, for example, Indium tin oxide (ITO) and are arranged in a matrix. In addition, on the pixel electrodes 9a, an alignment layer 16 is provided. The alignment layer 16 is formed of an organic material such as polyimide or an inorganic material composed of silicon oxide, titanium oxide, and so on. Below the pixel electrodes 9a, along the vertical and horizontal boundaries between the plurality of pixel electrodes 9a arranged in a matrix, conductive layers 33 such as data lines, scanning lines, or capacitor lines are formed.

The opposing substrate 20 is disposed parallel to and at a predetermined distance from the TFT array substrate 10 via spacers and a sealant (both not shown) therebetween. The opposing substrate 20 has an opposing electrode (common electrode) 21 formed on the liquid crystal layer 50 side thereof. The opposing electrode 21 is a transparent conductive layer formed of ITO. In addition, an alignment layer 22 is provided on the surface of the opposing electrode 21 that faces the liquid crystal layer 50. Above the opposing electrode 21, a lattice-like shielding layer 23 is formed so as to cover the gaps between the plurality of pixel electrodes 9a, viewed from the direction of an normal line to the opposing substrate 20.

On the opposite side of the TFT array substrate 10 from the liquid crystal layer 50, a polarizer 31 is disposed. On the opposite side of the opposing substrate 20 from the liquid crystal layer 50, a polarizer 32 is disposed. The arrangement of the polarizers 31 and 32 is the crossed Nicols arrangement.

As shown In FIG. 12A, when no voltage is applied between the pixel electrodes 9a and the opposing electrode 21, liquid crystal molecules 50a of the liquid crystal layer 50 are aligned by the controlling power of the alignment layers 16 and 22 so that the major axis direction of the liquid crystal molecules 50a is substantially parallel to the surfaces of the TFT array substrate 10 and the opposing substrate 20. As shown in FIG. 12B, when a voltage is applied between the pixel electrodes 9a and the opposing electrode 21, the liquid crystal molecules 50a of the liquid crystal layer 50 are aligned so as to be substantially perpendicular to the surfaces of the TFT array substrate 10 and the opposing substrate 20.

The TN mode liquid crystal display device 200 having the above-described configuration controls the transmittance ratio of light incident on the liquid crystal layer 50, utilizing the difference between the refractive indices in the major axis direction and in the minor axis direction of the liquid crystal molecules 50a, that is, the birefringence phenomenon.

When a sufficient voltage is applied between the pixel electrodes 9a and the opposing electrode 21 (FIG. 12B), linearly polarized light incident on the liquid crystal layer 50 through one of the polarizers 31 and 3 having polarization directions perpendicular to each other, is not emitted from the other polarizer (the pixels are black) because the light is not subjected to birefringence by the liquid crystal layer 50. On the other hand, when a sufficient voltage such that the liquid crystal molecules 50a are aligned substantially perpendicularly to the surfaces of the TFT array substrate 10 is not applied between the pixel electrodes 9a and the opposing electrode 21, linearly polarized light incident on the liquid crystal layer 50 through one of the polarizers 31 and 32 having polarization directions perpendicular to each other, is emitted from the other polarizer at a transmittance ratio according to the polarization state because the light is elliptically or circularly polarized by the birefringence according to the tilt angle of the liquid crystal molecules 50a. When no voltage is applied between the pixel electrodes 9a and the opposing electrode 21 (FIG. 12A), the transmittance ratio of light is largest (the pixels are white).

The TN mode liquid crystal display device 200 controls the applied voltage to the liquid crystal layer 50 so that a different voltage is applied to each pixel electrode 9a, and thereby each pixel has a different light transmittance ratio.

In the above-described TN mode liquid crystal display device 200, for example, when both of two adjacent pixels are black, a defect in alignment of liquid crystal molecules 50a occurs in regions R1 near the boundary between the pixels as shown in FIG. 13A. This is caused by an electric field (horizontal electric field) generated between the adjacent pixel electrodes 9a. In addition, an electric field generated between the conductive layer 33 disposed below the pixel electrodes 9a and the pixel electrodes 9a also causes such a defect in alignment of liquid crystal molecules 50a.

FIG. 13B is a graph showing the intensity of transmitted light in the range shown in FIG. 13A. The vertical axis indicates the intensity of transmitted light. The horizontal axis X is a coordinate axis substantially parallel to the surface of the TFT array substrate 10 and parallel to the paper surface of FIG. 13A. As shown in FIG. 13A, when both of adjacent pixels are black, it is preferable that the intensity of transmitted light be substantially zero throughout the region shown in FIG. 13B. However, as described above, in the TN mode liquid crystal display device 200, when a defect in alignment of liquid crystal molecules 50a occurs during black display, as shown in FIG. 13B with a curve T1, light leakage occurs in the regions R1, and the contrast is deteriorated.

For example, when one of two adjacent pixels is black and the other is white, a defect in alignment of liquid crystal molecules 50a called “reverse tilt” occurs in a region R2 near the boundary between the pixels as shown in FIG. 14A. FIG. 14B is a graph showing the intensity of transmitted light in the range shown in FIG. 14A. The vertical axis indicates the intensity of transmitted light. In the area R2 where the reverse tilt is occurring, as shown in FIG. 14B with a curve T2, light leakage due to a defect in alignment of liquid crystal molecules 50a occurs, and the contrast is deteriorated. In addition, the area R2 where the reverse tilt is occurring hinders the change in alignment of liquid crystal molecules 50a. Therefore, when the TN mode liquid crystal display device 200 displays a moving image, the display responsiveness deteriorates, and an afterimage phenomenon occurs.

In order to reduce such light leakage in a liquid crystal display device caused by a defect in alignment of liquid crystal molecules due to an electric field, JP-A-2000-214421 discloses a liquid crystal display device whose display quality is improved by making a liquid crystal material appropriate.

However, the art disclosed in JP-A-2000-214421 concerns an electrically controlled birefringence mode liquid crystal display device, and it cannot be applied to generally-used TN mode liquid crystal display devices.

In another known method for preventing light leakage, the opposing substrate 20 has a lattice-like shielding layer 23 formed so as to cover the regions R1 and R2 where a defect in alignment of liquid crystal occurs. Each strip of the lattice has a width W sufficient to cover the regions R1 and R2. However, the use of such a method reduces the aperture ratio of the liquid crystal display device.

### SUMMARY

A advantage of some aspects of the invention is to provide an electro-optical device and an electronic apparatus in which light leakage caused by a defect in alignment of liquid crystal is reduced without reducing the aperture ratio.

In an aspect of the invention, an electro-optical device includes a pair of substrates, and a liquid crystal layer between the substrates. At least one of the substrates has a plurality of scanning lines, a plurality of data lines, and pixel electrodes. The data lines intersect with the scanning lines. The pixel electrodes are disposed in a matrix and correspond to the intersections of the scanning lines with the data lines. When the elastic constant for splay distortion of a liquid crystal material forming the liquid crystal layer is K11, the elastic constant for bend distortion thereof is K33, the dielectric anisotropy thereof is Δ∈, and the rotational viscosity thereof is γ, the liquid crystal material satisfies the following conditions: 7 pN≦K11≦14 pN; 10 pN≦K33≦16 pN; 12≦Δε≦15; and 50 mPa·s≦γ≦100 mPa·s.

This configuration can make the region where a defect in alignment occurs near the boundary between adjacent pixel electrodes smaller than that of the known liquid crystal display device. Therefore, the width of each strip of a lattice-like shielding layer formed on the opposing substrate side in order to shield the leaking light in the places, can be reduced. Thus, it is possible to reduce light leakage caused by a defect in alignment of liquid crystal, without reducing the aperture ratio.

When the pretilt angle of the liquid crystal is θ0, and the thickness of the liquid crystal layer is d, it is preferable that θ0 and d satisfy the following conditions: 7°≦θ0≦20°; and 2.1 μm≦d≦2.3 μm.

This configuration can increase the brightness of the displayed image and reduce the afterimage when a moving image is displayed. When the distance between any adjacent two of the pixel electrodes is a1, it is preferable that a1 satisfy the following condition: 0.75 μm≦a1≦1.0 μm.

This configuration can maintain a high contrast and reduce the afterimage when a moving image is displayed.

In another aspect of the invention, an electronic apparatus includes the electro-optical device.

This configuration can display a bright, high-contrast, high-quality image.

### BRIEF DESCRIPTION OF THE DRAWINGS

The invention will be described with reference to the accompanying drawings, wherein like numbers reference like elements.

FIG. 1 is a plan view of an electro-optical device and shows a TFT array substrate and components formed thereon viewed from the opposing substrate side.

FIG. 2 is a sectional view taken along line II-II of FIG. 1.

FIG. 3 shows an equivalent circuit including various elements and lines in a plurality of pixels that are formed in a matrix and that constitute an image display region of the electro-optical device.

FIG. 4 is a sectional view showing an example of configuration of a projection color display apparatus.

FIG. 5 is a graph showing the relationship between the elastic constant K11 for splay distortion of the liquid crystal material and the afterimage level L.

FIG. 6 is a graph showing the relationship between the elastic constant K33 for bend distortion of the liquid crystal material and the afterimage level L.

FIG. 7 is a graph showing the relationship between the dielectric anisotropy Δε of the liquid crystal material and the afterimage level L.

FIG. 8 is a graph showing the relationship between the rotational viscosity γ of the liquid crystal material, and the transmittance ratio T10 of a pixel 10 ms after the pixel is switched from black to white.

FIG. 9 is a graph showing the relationship between the pretilt angle θ0, the transmittance ratio T, and the afterimage level L.

FIG. 10 is a graph showing the relationship between the thickness d of the liquid crystal layer, the transmittance ratio T, and the afterimage level L.

FIG. 11 is a graph showing the relationship between the distance a1 between adjacent pixel electrodes, the contrast C, and the afterimage level L.

FIGS. 12A and 12B illustrate the configuration and the operation mode of a known liquid crystal display device.

FIGS. 13A and 13B illustrate the light leakage between adjacent pixel electrodes.

FIGS. 14A and 14B illustrate the light leakage between adjacent pixel electrodes.

### DESCRIPTION OF EXEMPLARY EMBODIMENTS

The exemplary embodiments of the invention will now be described with reference to the drawings. In the following exemplary embodiments, the electro-optical device of the invention is applied to a liquid crystal display device.

### Configuration of Electro-Optical Device

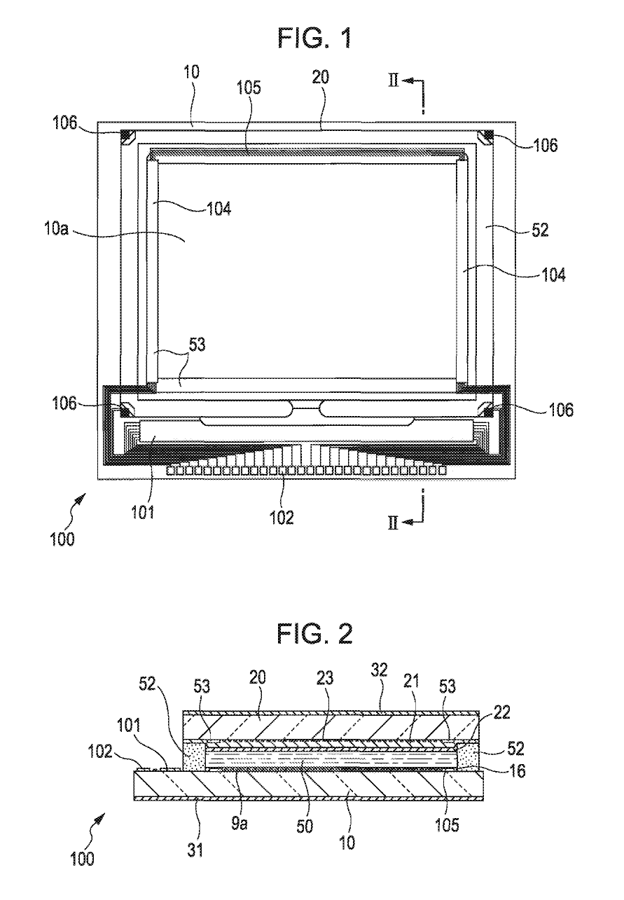

First, the configuration of the electro-optical device according to an exemplary embodiment of the invention will be described with reference to FIGS. 1 to 3, 12A, and 12B. As an example of an electro-optical device, a TFT active matrix drive liquid crystal display device 100 with a built-in drive circuit will be taken. The liquid crystal display device 100 operates in a so-called twisted nematic (hereinafter referred to as TN) mode.

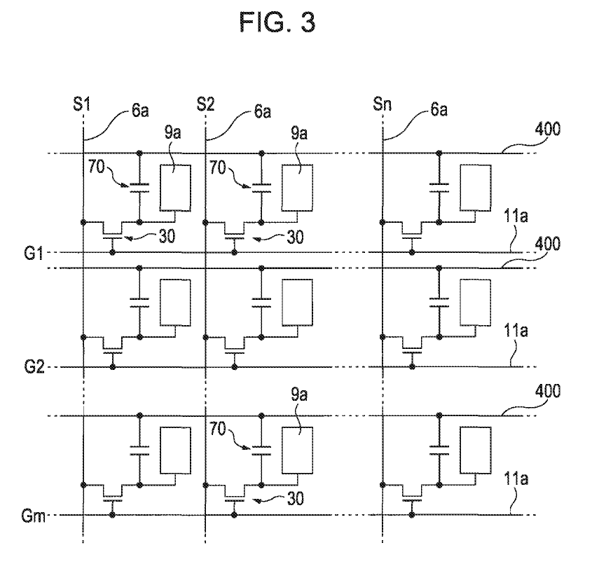

FIG. 1 is a plan view of an electro-optical device and shows a TFT array substrate and components formed thereon viewed from the opposing substrate side. FIG. 2 is a sectional view taken along line II-II of FIG. 1. FIG. 3 shows an equivalent circuit including various elements and lines in a plurality of pixels that are formed in a matrix and that constitute an image display region of the electro-optical device. In each figure used for illustrating the exemplary embodiments, each layer or each member is shown a different scale so that each layer or each member can have a sufficiently understandable size.

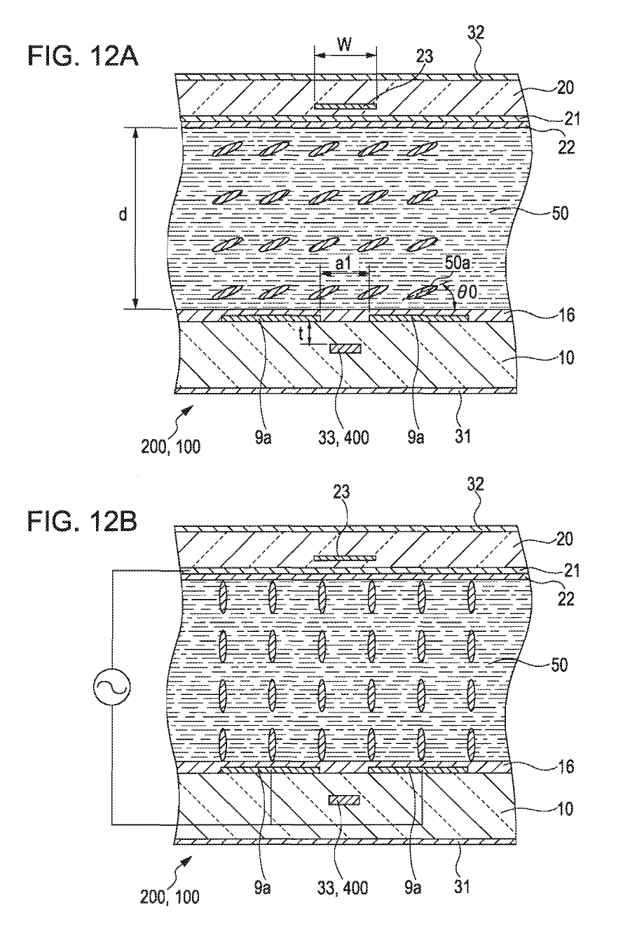

Since the liquid crystal display device 100 of the exemplary embodiment has the same basic configuration as the known TN mode liquid crystal display device 200 described with reference to FIGS. 12A and 12B, the same reference numerals will be used to designate components having the same functions.

In FIGS. 1 and 2, the liquid crystal display device 100, which is an electro-optical device according to the exemplary embodiment, includes a TFT array substrate 10 and an opposing substrate 20 facing each other, and a liquid crystal layer 50 therebetween, which is an electro-optical material. The liquid crystal display device 100 of the exemplary embodiment controls the alignment and order of liquid crystal molecules 50a of the liquid crystal layer 50 between the TFT array substrate 10 and the opposing substrate 20, thereby modulating light and displaying an image in an image display region 10a. The TFT array substrate 10 and the opposing substrate 20 are rectangular light-transmissive plate-like members such as quartz substrates or glass substrates. The TFT array substrate 10 and the opposing substrate 20 are glued to each other with a sealant 52 provided in a seal region around the image display region 10a.

The sealant 52 is formed of, for example, an ultraviolet curing resin or a thermosetting resin for gluing the substrates together. After applied to the TFT array substrate 10 in the manufacturing process, the sealant 52 is cured by ultraviolet radiation, heating, or the like. In order to set the distance between the TFT array substrate 10 and the opposing substrate 20 (intersubstrate gap) to a predetermined value, spacers, for example, glass fibers or glass beads, are scattered in the sealant 52. When the liquid crystal device is a large liquid crystal device that displays an image at 1× magnification such as a liquid crystal display or a liquid crystal television, such spacers may be contained in the liquid crystal layer 50.

In the exemplary embodiment, when no voltage is applied, the pretilt angle θ0 of the liquid crystal molecules 50a controlled by the alignment layers 16 and 22 satisfies the following condition: 7°≦θ0≦20°, and the thickness d of the liquid crystal layer 50 satisfies the following condition: 2.1 μm≦d≦2.3 μm (see FIG. 12A).

As will hereinafter be described in detail, setting the pretilt angle θ0 of the liquid crystal molecules 50a and the thickness d of the liquid crystal layer 50 within the above conditions makes it possible to reduce the afterimage phenomenon when a moving image is displayed and to increase the transmittance ratio of pixels of the liquid crystal display device 100.

In parallel with and inside the seal region where the sealant 52 is disposed, a frame region defines the image display region 10a. A peripheral shielding layer 53 is provided on the opposing substrate 20 side of the frame region.

In a region lying outside the seal region where the sealant 52 is disposed, a data line driving circuit 101 and external circuit connecting terminals 102 are provided along one side of the TFT array substrate 10. In addition, scanning line driving circuits 104 are provided along two sides adjacent to the one side so as to be covered by the peripheral shielding layer 53. Moreover, in order to connect the two scanning line driving a circuits 104 provided on both sides of the image display region 10a, a plurality of lines 105 are provided along the other one side of the TFT array substrate 10 so as to be covered by the peripheral shielding layer 53.

In the four corners of the opposing substrate 20, vertical conductive members 106 are provided. The vertical conductive members 106 function as vertical conductive terminals between both substrates. On the other hand, on the TFT array substrate 10, vertical conductive terminals are provided in regions opposite these corners. The vertical conductive members 106 and the vertical conductive terminals establish electric conduction between the TFT array substrate 10 and the opposing substrate 20.

In FIG. 2, an alignment layer 16 is formed on the TFT array substrate 10, or more specifically on pixel electrodes 9a after TFTs for pixel switching and lines such as scanning lines and data lines are formed. On the other hand, on the opposing substrate 20, in addition to the opposing electrode 21, a lattice-like shielding layer 23 or stripe-like shielding layers are provided. In addition, the opposing substrate 20 has an alignment layer 22 formed on the most liquid crystal layer 50 side thereof. The liquid crystal layer 50 is formed of a liquid crystal material that is, for example, one type of nematic liquid crystal or a mixture of several types of nematic liquid crystal. As described with reference to FIG. 12A, the liquid crystal layer 50 is in a predetermined alignment state between the pair of alignment layers 16 and 22.

The data line driving circuit 101 and the scanning line driving circuits 104 include TFTs therefor, which are formed together with the TFTs for switching pixels. On the TFT array substrate 10 shown in FIGS. 1 and 2, in addition to the data line driving circuit 101, the scanning line driving circuits 104, and so on, a sampling circuit, a precharging circuit, an inspection circuit, and so on may be formed. The sampling circuit samples image signals on image signal lines and supplies the image signals to the data lines. The precharging circuit supplies the plurality of data lines with precharging signals at a predetermined voltage level before the supply of image signals. The inspection circuit inspects the quality, defects, and so on of the electro-optical device during manufacture or before shipping.

The opposing substrate 20 has a polarizer 32 disposed on the side thereof on which projection light is incident. The TFT array substrate 10 has a polarizer 31 disposed on the side thereof from which light is emitted. The arrangement of the polarizers 31 and 32 is the crossed Nicols arrangement.

In FIG. 3, each of the plurality of pixels arranged in a matrix and constituting the image display region of the electro-optical device of the exemplary embodiment, has a pixel electrode 9a and a TFT 30 for switching the pixel electrode 9a. The source of the TFT 30 is electrically connected to a data line 6a to which an image signal is supplied. Image signals S1, S2, . . . , Sn to be written into the data lines 6a may be sup-plied in this order one line at a time, or may be supplied to each group of a plurality of data lines 6a adjacent to each other.

In the exemplary embodiment, the distance a1 (see FIG. 12A) between the plurality of pixel electrodes 9a arranged in a matrix is set so as to satisfy the following condition 0.75 μm≦a1≦1.0 μm. Setting the distance a between adjacent pixel electrodes 9a within the above condition makes it possible to reduce the afterimage phenomenon when a moving image is displayed and to increase the contrast of the liquid crystal display device 100.

In addition, the gate of each TFT 30 is electrically connected to a scanning line 11a. Scanning signals G1, G2, . . . , Gm are applied, at a predetermined timing, to the scanning lines 11a in pulses in this order one line at a time. Each pixel electrode 9a is electrically connected to the drain of the corresponding TFT 30. The switch of the TFT 30, which acts as a switching element, is closed for a certain period of time. Thus, the image signals S1, S2, . . . , Sn supplied from the data lines 6a are written into the pixels of the scanning line 11a selected at a predetermined timing.

The image signals S1, S2, . . . , Sn at predetermined levels written into the pixels are held between the pixel electrodes 9a and the opposing electrode formed on the opposing substrate for a certain period of time. The alignment and order of molecular groups of the liquid crystal are changed according to the applied voltage level so as to modulate light, thereby making the gray-scale display possible. The liquid crystal display device 100 of the exemplary embodiment is in the normally white mode, in which the transmittance ratio for incident light is decreased according to the voltage applied to each pixel. On the other hand, in the case of the normally black mode, the transmittance ratio for incident light is increased according to the voltage applied to each pixel, and on the whole, the electro-optical device emits light having a contrast according to the image signals.

In order to prevent the held image signals from leaking, capacitor elements 70 are added in parallel with liquid crystal capacitors formed between the pixel electrodes 9a and the opposing electrode. The capacitor elements 70 are disposed along the scanning lines 11a. The fixed-potential capacitor electrodes of the capacitor elements 70 are connected to capacitor lines 400 fixed at a constant potential.

The capacitor lines 400 are formed, as shown in FIG. 3, along the vertical and horizontal boundaries between the plurality of pixel electrodes 9a arranged in a matrix, and as shown in FIG. 12A, below the pixel electrodes 9a. The capacitor lines 400 are disposed so as to be at a distance t from the pixel electrodes 9a. An interlayer insulating film is disposed between the capacitor lines 400 and the pixel electrodes 9a. In the exemplary embodiment, the distance t between the capacitor lines 400 and the pixel electrodes 9a is set so as to satisfy the following condition: 6000 angstrom≦t≦10000 angstrom. The liquid crystal display device 100 is driven so that the potential of the capacitor lines 400 is at least 0 V and no more than 10 V.

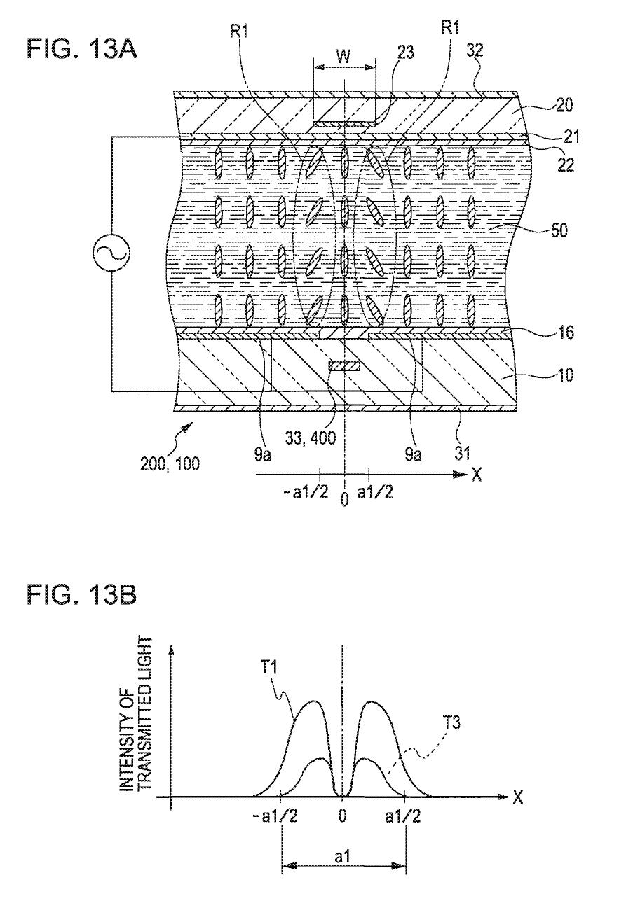

As described above, the capacitor lines 400, which are conductive layers formed along the vertical and horizontal boundaries between the pixel electrodes 9a, are disposed so as to be at a distance t from the pixel electrodes 9a. In addition, the potential of the capacitor lines 400 is set within a predetermined range. Therefore, the effect of the electric field generated between the capacitor lines 400 and the pixel electrodes 9a, on the alignment of the liquid crystal molecules 50a of the liquid crystal layer 50, can be reduced. Therefore, the region R1 shown in FIG. 13A where the electric field generated between the capacitor lines 400 and the pixel electrodes 9a causes a defect in alignment of the liquid crystal molecules 50a, can be reduced.

In the liquid crystal display device 100 of the exemplary embodiment, when the elastic constant for splay distortion of the Liquid crystal, material forming the liquid crystal layer 50 is K11, the elastic constant for bend distortion thereof is K33, the dielectric anisotropy thereof is Δε, and the rotational viscosity thereof is γ, at room temperature (20° C. in the exemplary embodiment), the liquid crystal material satisfies the following conditions: 7 pN≦K11≦14 pN; 10 pN≦K33≦16 pN; 12≦Δε≦15; and 50 mPa·s≦γ≦100 mPa·s.

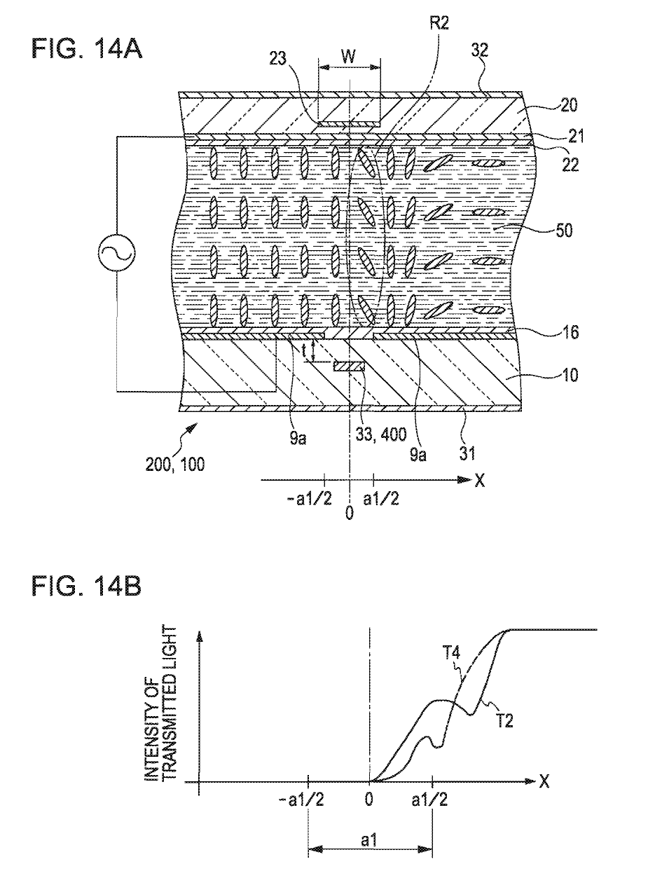

In the liquid crystal display device 100 having the liquid crystal layer 50 formed of such a liquid crystal material, the region where a defect in alignment occurs near the boundary between adjacent pixel electrodes 9a is smaller than that of the known liquid crystal display device. Therefore, as shown in FIG. 13B with a curve T3 and in FIG. 14B with a curve T4, even when a defect in alignment of the liquid crystal molecules 50a occurs due to the effect of the surrounding electric field and the reverse tilt, light leakage in the place is smaller than that of the known liquid crystal display device. Therefore, the width of each strip of the lattice-like shielding layer 23 formed on the opposing substrate 20 side in order to shield the leaking light in the place, can be reduced. Thus, in the liquid crystal display device 100 of the exemplary embodiments, it is possible to reduce light leakage caused by a defect in alignment of liquid crystal, without reducing the aperture ratio.

### Configuration of Electronic Apparatus

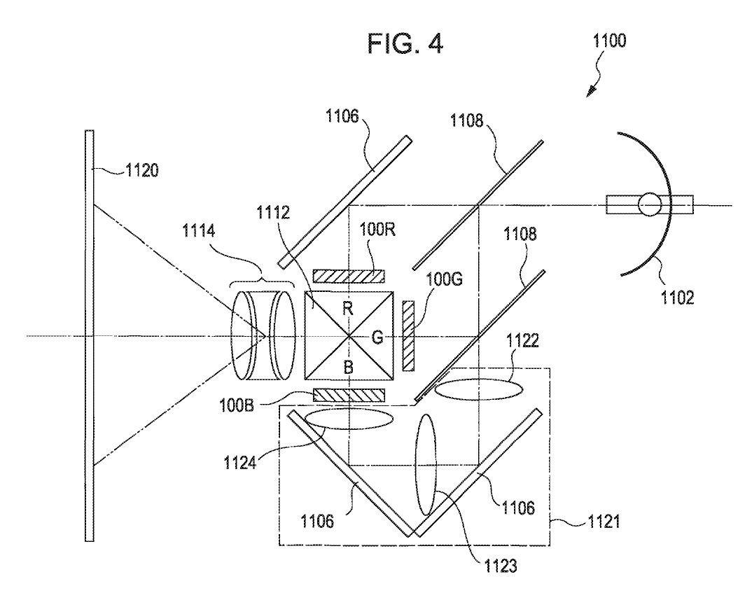

Next, an exemplary embodiment of a projection color display apparatus as an example of an electronic apparatus including the liquid crystal display device 100 described above in detail as a light valve, the entire configuration thereof, in particular, an optical configuration will be described. FIG. 4 is a sectional view showing an example of configuration of a projection color display apparatus. In FIG. 4, a liquid crystal projector 1100, which is a projection color display apparatus, includes three liquid crystal modules each including a liquid crystal device 1100 according to the exemplary embodiment. The three liquid crystal modules are used as RGB light valves 100R, 100G, and 100B. In the liquid crystal projector 1100, projection light emitted from a lamp unit 1102, which is a white light source such as a metal halide lamp, is separated by three mirrors 1106 and two dichroic mirrors 1108 into light components R, G, and B corresponding to three primary colors RGB. The components are respectively guided to light valves 100R, 100G, and 100B corresponding to each color. At this time, in particular, the B light is guided by a relay lens system 1121 including an incident lens 1122, a relay lens 1123, and an output lens 1124 in order to prevent light loss due to a long optical path. Light components corresponding to the three primary colors are respectively modulated by the light valves 100R, 100G, and 100B, and are then recombined by a dichroic prism 1112. The recombined light is projected as a color image on a screen 1120 via a projection lens 1114.

The liquid crystal projector 1100 of the exemplary embodiment shown in FIG. 4 includes the liquid crystal display devices 100 according to the exemplary embodiment. Since the liquid crystal display devices 100 have a higher aperture ratio and less light leakage than the known liquid crystal display device, the liquid crystal projector 1100 can display a brighter and higher-contrast image.

The liquid crystal display device 100 according to the exemplary embodiment can be applied to not only the electronic apparatus described with reference to FIG. 4 but also other various electronic apparatuses, for example, mobile computers, liquid crystal televisions, cellular telephones, electronic notebooks, word processors, camcorders (viewfinders and screens), workstations, videophones, POS terminals, touch panels, and electronic papers.

### EXAMPLES

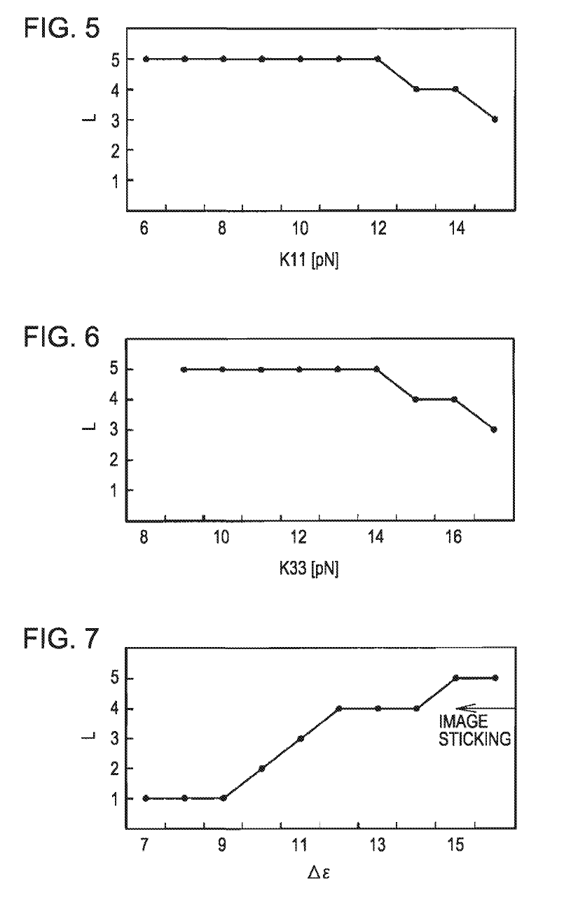

Simulations were performed before the property of the liquid crystal material forming the liquid crystal layer 50 and parameters of the liquid crystal display device 100 were determined. The parameters have been described with reference to FIGS. 12A and 12B. The simulation results will be described with reference to the graphs of FIGS. 5 to 11.

FIG. 5 shows the relationship between the elastic constant K11 for splay distortion of the liquid crystal material and the afterimage level L. FIG. 6 shows the relationship between the elastic constant K33 for bend distortion of the liquid crystal material and the afterimage level L. In the graph of FIG. 5, the horizontal axis indicates the elastic constant K11 (pN), and the vertical axis indicates the afterimage level L. In the graph of FIG. 6, the horizontal axis indicates the elastic constant K33 (pN), and the vertical axis indicates the afterimage level L.

The afterimage level L indicates, on a scale of 1 to 5, the level of the afterimage when a moving image is displayed in the liquid crystal display device 100. The moving image is such that a black periodic pattern moves in an entirely white screen at a constant speed. The larger the value of the afterimage level L, the more sharply the liquid crystal display device 100 can display the moving image, and the less afterimage an observer can detect. That is to say, the larger the value of the afterimage level L, the shorter the response time of the liquid crystal display device 100 when switching is performed from black to white, for example.

More specifically, when the afterimage level L is 1, a generated afterimage never disappears. When the afterimage level L is 2, a generated afterimage remains until next pattern is written into the place. That is to say, when the afterimage level L is 1 or 2, a generated afterimage does not disappear by itself. When the afterimage level L is 3, although a generated afterimage disappears by itself, it is noticeable. When the afterimage level L is 4, a generated afterimage disappears rapidly and causes no trouble in displaying a moving image. When the afterimage level L is 5, no afterimage is generated, and this level is therefore ideal for displaying a moving image. In the invention, each parameter is determined so that the afterimage level L is 4 or more.

As shown in FIG. 5, in the case where the elastic constant K11 for splay distortion of the liquid crystal material is changed from 6 pN to 15 pN, when K11 is larger than 14 pN, the afterimage level L is 3 or less. In addition, as shown in FIG. 6, in the case where the elastic constant K33 for bend distortion of the liquid crystal material is changed from 9 pN to 17 pN, when K33 is larger than 16 pN, the afterimage level L is 3 or less. Therefore, in the exemplary embodiment, the elastic constant K11 is 14 pN or less and the elastic constant K33 is 16 pN or less so that the afterimage when a moving image is displayed can be reduced.

Next, FIG. 7 shows the relationship between the dielectric anisotropy Δε of the liquid crystal material and the afterimage level L. In the graph of FIG. 7, the horizontal axis indicates the dielectric anisotropy Δε, and the vertical axis indicates the afterimage level L.

As shown in FIG. 7, when the dielectric anisotropy Δε is 12 or more, the afterimage level L is 4 or more. In addition, as shown in FIG. 7, in the case where the dielectric anisotropy Δε is more than 15, when a still image is displayed, image sticking occurs in the liquid crystal display device 100. Therefore, in the exemplary embodiment, the dielectric anisotropy Δε is at least 12 and no more than 15. Within this range, image sticking does not occur, and the afterimage when a moving image is displayed can be reduced.

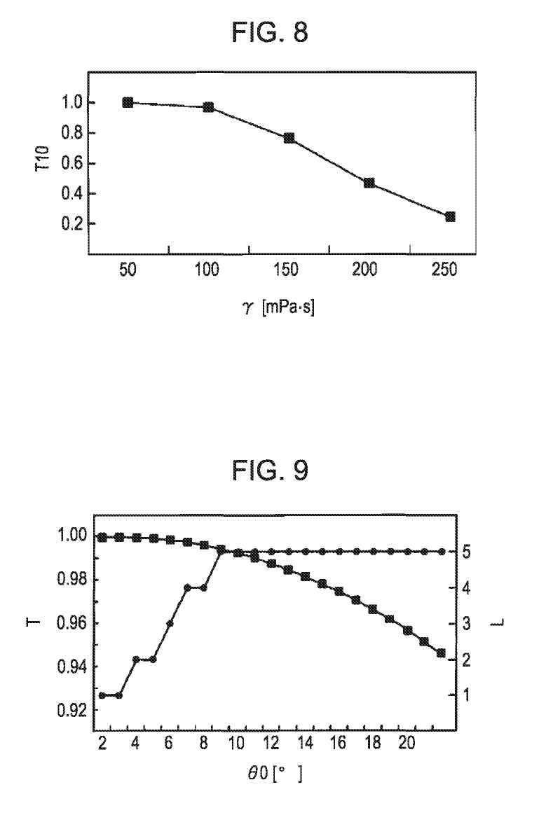

Next, FIG. 8 shows the relationship between the rotational viscosity γ of the liquid crystal material, and the transmittance ratio T10 of a pixel 10 ms after the pixel is switched from black to white, that is, 10 ms after the voltage value applied to the liquid crystal layer 50 is switched from a voltage value for black display to 0 V. In the graph of FIG. 8, the horizontal axis indicates the rotational viscosity γ (mPa·s, and the vertical axis indicates the transmittance ratio T10. The transmittance ratio T10 shows the transmittance ratio of a predetermined pixel 10 ms after the pixel is switched from black to white. The closer to 1 this value (T10), the shorter the response time of the liquid crystal display device 100 required to switch a pixel from black to white. In order to ideally display a moving image, a liquid crystal display device can preferably switch a pixel from black to white within 10 ms. Therefore, in the exemplary embodiment, the value of the rotational viscosity γ is determined so that T10 is greater than or equal to 0.95.

As shown in FIG. 8, when the rotational viscosity γ is 100 mPa·s or less, T10 is greater than or equal to 0.95. Therefore, in the exemplary embodiment, the rotational viscosity γ is 100 mPa·s or less. This can reduce the response time of liquid crystal.

Next, FIG. 9 shows the relationship between the pretilt angle θ0 of the liquid crystal molecules 50a of the liquid crystal layer 50 controlled by the alignment layers 16 and 22, the transmittance ratio T, and the afterimage level L. In the graph of FIG. 9, the horizontal axis indicates the pretilt angle θ0 (degree), and the vertical axis indicates the transmittance ratio T10 and the afterimage level L. In FIG. 9, the transmittance ratio T is plotted with black squares, and the afterimage level L is plotted with black circles. In the exemplary embodiment, the transmittance ratio T is preferably greater than or equal to 0.95. The pretilt angle θ0 is the average of pretilt angles of liquid crystal molecules 50a controlled by both of the pair of alignment layers 16 and 22 disposed so as to sandwich the liquid crystal layer 50.

As shown in FIG. 9, when the pretilt angle θ0 is 7 (degrees) or more, the afterimage level L is 4 or more. The larger the pretilt angle θ0, the lower the transmittance ratio T. The transmittance ratio T is 0.95 or less when the pretilt angle θ0 is 22 (degrees) or more. In manufacturing, it is difficult to stably tilt the liquid crystal molecules 50a at a pretilt angle of 20 degrees or more. Therefore, in the exemplary embodiment, the pretilt angle θ0 is at, least 7 degrees and no more than 20 degrees. This can reduce the afterimage when a moving image is displayed.

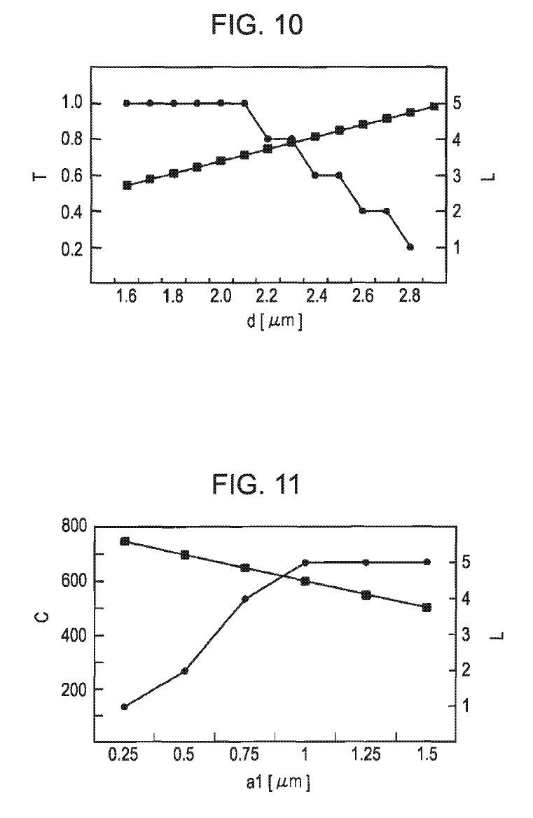

Next, FIG. 10 shows the relationship between the thickness d of the liquid crystal layer 50, the transmittance ratio T, and the afterimage level L. In the graph of FIG. 10, the horizontal axis indicates the thickness d (μm) of the liquid crystal layer 50, and the vertical axis indicates the transmittance ratio T and the afterimage level L. In FIG. 10, the transmittance ratio T is plotted with black squares, and the afterimage level L is plotted with black circles. In the exemplary embodiment, the transmittance ratio T is preferably greater than or equal to 0.7.

As shown in FIG. 10, when the thickness d of the liquid crystal layer 50 is at least 2.1 μm and no more than 2.3 μm, the afterimage level L is 4 or more and the transmittance ratio T is 0.7 or more. Therefore, in the exemplary embodiment, the thickness d of the liquid crystal layer 50 is at least 2.1 μm and no more than 2.3 μm. Thus, in the liquid crystal display device 100 of the exemplary embodiment, it is possible to increase the brightness of the displayed image and to reduce the afterimage when a moving image is displayed.

Next, FIG. 11 shows the relationship between the distance a1 between adjacent pixel electrodes 9a, the contrast C, and the afterimage level L. In the graph of FIG. 11, the horizontal axis indicates the distance a1 (μm) between adjacent pixel electrodes 9a, and the vertical axis indicates the contrast C and the afterimage level L. In FIG. 11, the contrast C is plotted with black squares, and the afterimage level L is plotted with black circles. In the exemplary embodiment, the contrast C is a proportion of the luminance in the white display region to the luminance in the black display region of the liquid crystal display device 100. The contrast C is preferably greater than or equal to 600.

As shown in FIG. 11, when the distance a1 between adjacent pixel electrodes 9a is at least 0.75 μm and no more than 1 μm, the afterimage level L is 4 or more and the contrast C is 600 or more. Therefore, in the exemplary embodiment, the distance a1 between adjacent pixel electrodes 9a is at least 0.75 μm and no more than 1 μm. Thus, in the liquid crystal display device 100 of the exemplary embodiment, it is possible to maintain a high contrast and to reduce the afterimage when a moving image is displayed.

In the liquid crystal display device 100 of the exemplary embodiment, values of characteristics of the liquid crystal material forming the liquid crystal layer 50 and values of the pretilt angle θ0, the thickness d of the liquid crystal layer, and the distance a1 between pixel electrodes 9a are set on the basis of the above-described simulation results.

The curve T3 in FIG. 13B and the curve T4 in FIG. 14B show the measurement results of light leakage near the boundary between adjacent pixels in a liquid crystal display device 100 having a liquid crystal layer 50 formed of such a liquid crystal material.

In the liquid crystal display device 100 of the exemplary embodiment, even in the case where both of adjacent pixels are black, and a defect in alignment of the liquid crystal molecules 50a occurs due to the surrounding electric field, light leakage in the place is smaller than that of the known liquid crystal display device, as shown in FIG. 13B with a curve T3. More specifically, as shown in FIG. 13B with the curve T3, the peak intensity of light leakage during black display is less than half of that of the known liquid crystal display device (T1). That is to say, the liquid crystal display device 100 of the exemplary embodiment is capable of higher contrast display than the known liquid crystal display device. The reason of this is that, in the liquid crystal display device 100 of the exemplary embodiment, the region R1 where a defect in alignment of liquid crystal molecules 50a occurs near the boundary between adjacent pixels, is smaller than that of the known liquid crystal display device. As described above, in the liquid crystal display device 100 of the exemplary embodiment, the region R1 where a defect in alignment of liquid crystal molecules 50a occurs, is smaller than that of the known liquid crystal display device. Therefore, the width W of the shielding layer 23 formed on the opposing substrate 20 side can be smaller than that of the known liquid crystal display device. Thus, it is possible to increase the aperture ratio, without deteriorating the display quality, so as to display a brighter image than the known liquid crystal display device.

In addition, even in the case where two adjacent pixels are respectively white and black and a defect in alignment of liquid crystal molecules 50a occurs due to reverse tilt, light leakage in the place is smaller than that of the known liquid crystal display devices as shown in FIG. 14B with a curve T4.

More specifically, as shown in FIG. 14B with the curve T4, the peak intensity of light leakage in the region R2 where reverse tilt occurs, is less than half of that of the known liquid crystal display device (T2). In addition, the region where the intensity of transmitted light is a predetermined value or more, that is, the region of white display is nearer to the boundary between the pixels than that of the known liquid crystal display device. That is to say, in the liquid crystal display device 100 of the exemplary embodiment, the boundary between a white pixel and a black pixel is sharper, and the contrast is higher than that of the known liquid crystal display device. The reason of this is that, in the liquid crystal display device 10 of the exemplary embodiment, the region R2 where a defect in alignment of liquid crystal molecules 50a occurs due to reverse tilt near the boundary between adjacent pixels, is smaller than that of the known liquid crystal display device. As described above, in the liquid crystal display device 100 of the exemplary embodiment, the region R2 where reverse tilt occurs is smaller than that of the known Liquid crystal display device. Therefore, the width W of the shielding layer 23 formed on the opposing substrate 20 side can be smaller than that of the known liquid crystal display device. Thus, it is possible to increase the aperture ratio, without deteriorating the display quality, so as to display a brighter image than the known liquid crystal display device.

Therefore, it is turned out that, in the liquid crystal display device 100 of the exemplary embodiment, it is possible to reduce light leakage caused by a defect in alignment of liquid crystal without reducing the aperture ratio.

It is to be understood that the present invention is not intended to be limited to the above-described exemplary embodiments, and various changes may be made therein without departing from the scope or spirit of the present invention readable from the claims and the entire specification. An electro-optical device and an electronic apparatus in which such changes are made are also included in the technical scope of the present invention.

In the exemplary embodiment, a transmissive TFT active matrix liquid crystal display device is described. However, the present invention can also be applied to, for example, a reflective liquid crystal display device such as an LCOS, and a transflective liquid crystal display device.

The entire disclosure of Japanese Patent Application No. 2006-070681, filed Mar. 15, 2006 is expressly incorporated by reference herein.

What is claimed is:

1. An electro-optical device comprising:
a pair of substrates; and
a liquid crystal layer between the substrates,
at least one of the substrates having a plurality of scanning lines, a plurality of data lines, and pixel electrodes, the data lines intersecting with the scanning lines, the pixel electrodes being disposed in a matrix and corresponding to the intersections of the scanning lines with the data lines,
wherein when the elastic constant for splay distortion of a liquid crystal material forming the liquid crystal layer is K11, the elastic constant for bend distortion thereof is K33, the dielectric anisotropy thereof is Δε, and the rotational viscosity thereof is γ, the liquid crystal material satisfies the following conditions:
7 pN≦K11≦14 pN
10 pN≦K33≦16 pN
12≦Δε≦15
50 mPa·s≦γ≦100 mPa·s.

2. The electro-optical device according to claim 1, wherein when the pretilt angle of the liquid crystal is θ0, and the thickness of the liquid crystal layer is d, θ0 and d satisfy the following conditions:
7°≦θ0≦20°
2.1 μm≦d≦2.3 μm.

3. The electro-optical device according to claim 1, wherein when the distance between any adjacent two of the pixel electrodes is a1, a1 satisfies the following condition:
0.75 μm≦a1≦1.0 μm.

4. An electronic apparatus comprising the electro-optical device according to claims 1.
